(19) United States
(12) Patent Application Publication
(10) Pub. No.: US 2007/0166561 A1
(43) Pub. Date: Jul. 19, 2007

(54) Composite bodies, method for the production thereof and use thereof

(75) Inventors: Ursula Ziegler, Mainz (DE); Frank Reil, Seeheim-Jugenheim (DE); Klaus Kurz, Kelsterbach (DE)

Correspondence Address: CONNOLLY BOVE LODGE & HUTZ, LLP, P O BOX 2207, WILMINGTON, DE, 19899, US

(73) Assignee: TICONA GmbH, Kelsterbach (DE)

(21) Appl. No.: 10/584,746

(22) PCT Filed: Dec. 22, 2004
(86) PCT No.: PCT/EP04/14562

§ 371 Date: Jul. 17, 2006

(30) Foreign Application Priority Data
Dec. 24, 2003 (DE) 103 61 230.0

(51) Int. Cl. B32B 27/36

(52) U.S. Cl. 428/480; 428/524; 264/255; 264/328.8

(57) ABSTRACT

Composites are described, comprising polyacetal and at least one thermoplastic polyester elastomer formed by a polyacetal molding which has been partially or completely coated with the thermoplastic polyester elastomer or onto which one or more moldings composed of the thermoplastic polyester elastomer have been directly molded. The composites are characterized in that the polyacetal and the thermoplastic polyester elastomer have been bonded adhesively or cohesively to one another via injection of the thermoplastic polyester elastomer onto the polyacetal molding, and in that the tensile bond strength between the polyacetal and the thermoplastic polyester elastomer is at least 0.5 N/mm². The composites may be used as connectors, as functional components with integrated sealing properties and/or with integrated damping properties, or else as non-slip and easy-grip elements.

The present invention relates to composites composed of a combination of the engineering material polyoxymethylene with functional elements directly molded-on and composed of one or more thermoplastic polyester elastomers (TPEE), to their production, and also to their use.

The engineering material polyacetal, i.e. polyoxymethylene (also termed POM or polyacetal below) has excellent mechanical properties and is moreover generally also resistant toward all of the usual solvents and fuels. Moldings composed of polyoxymethylene are therefore used inter alia in automobile construction, and in particular even in fuel-conveying systems.

Moldings composed of polyacetal are very often used in all sectors of everyday life for snap connectors, in particular clips, because of good strength and hardness combined with excellent rebound resilience.

Excellent sliding friction properties are the reason for use of polyoxymethylene for many moveable parts, e.g. gearbox parts, deflector rolls, gearwheels, or shift levers. Housings and keyboards are also produced from polyoxymethylene, the reason being very good mechanical resistance and chemicals resistance.

However, POM has a low mechanical damping factor at room temperature, and in some applications this necessitates use of soft damping elements. When moldings composed of polyoxymethylene are installed, connection sites also often require a seal. The high surface hardness of moldings composed of POM, and the low coefficient of sliding friction of POM, can lead to slip of superposed articles and can create risk in the operation of switching units and control units composed of POM.

On the other hand, it is true that combinations composed of hard and soft materials are used with increasing frequency, in order to achieve a mutual combination of the particular properties of these materials. The hard material here is intended to give the components their strength, and because the soft material has elastic properties it assumes functions related to sealing or vibration-damping and sound-deadening, or brings about a change in surface feel.

In these applications it is important that there is sufficient adhesion between the hard component and the soft component.

One of the methods used hitherto provides gaskets and damping elements separately and usually uses an additional operation for their mechanical anchoring or adhesive-bonding, thus generating additional work and sometimes considerable additional costs. A more modern and more cost-effective method is multicomponent injection molding. In this, by way of example, a second component is molded onto a previously molded first component. The adhesion achievable between the two components is of great importance for this process. Although this adhesion in multicomponent injection molding can often be further improved via introduction of undercuts within interlocking connections, good underlying adhesion via chemical affinity between the selected components is often a precondition for their use.

Examples of well-known combinations produced by multicomponent injection molding are composed of polypropylene (PP) and of polyolefin elastomers or of styrene/olefin elastomers, polybutylene terephthalate (PBT) with polyester elastomers or with styrene/olefin elastomers. Polyamides, too, adhere to many soft components.

Thermoplastic elastomers are said to be in principle capable of combination with thermoplastics in the overmolding, by way of example polyurethane elastomers (TPEU) adhering to POM (Kunststoffe 84 (1994) p. 709 and Kunststoffe 86, (1996), p. 319). Those publications give no adhesion for the combination of POM with TPEE (polyester elastomer). According to those overview articles, therefore, an adhesive bond derived from POM and TPEE is hitherto unknown.

EP-A-818,294 describes axles or rollers with a specific design and comprising bonding combinations composed of a first and second thermoplastic material. Possible materials listed are, inter alia, POM and thermoplastic elastomers based on polyether block esters. The bonding can be produced via adhesive, cohesive, or mechanical bonding. There are no specific examples listed for adhesive or cohesive POM/TPEE bonding. Because the production of bonding of this type is problematic, the absence of some specific examples thereof has to be taken as implying that that specification discloses no adhesive or cohesive POM/TPEE bonding.

EP-A-816,043 discloses materials combinations composed of hard thermoplastics, such as POM, and of soft thermoplastics. That document gives no indication of an adhesive bond between POM and thermoplastic polyamide elastomers.

Materials combinations described in WO-A-99/16,605 comprise POM/thermoplastic polyurethane elastomer. Again, there is no mention of thermoplastic polyester elastomers.

U.S. Pat. No. 6,082,780 discloses pipes around which thermoplastic or elastomer has been injected. A very wide variety of polymers is disclosed for the pipe and, respectively, for the sheath. POM and thermoplastic polyester elastomers are listed, inter alia as material for the pipe and/or the sleeve. Alongside a large number of polymer combinations that can give adhesive bonding systems between the materials, that document also discloses numerous combinations which do not give adhesion. Because the production of bonding between POM and thermoplastic elastomers is problematic, the absence of some specific examples thereof has to be taken as implying that that specification discloses no adhesive POM/TPEE bonding.

WO 99/30,913 describes rotatable plastics rollers. That document discloses thermoplastic polyester elastomers, but does not disclose combinations of these with polyoxymethylene.

DE-A-4,109,936 describes interior door handles. That document mentions, inter alia, polyoxymethylene as “hard plastic” and, inter alia, thermoplastic polyester elastomers as “soft plastic”. That document cannot be deemed to suggest the combination of polyoxymethylene with polyamide elastomers or their adhesive or cohesive bonding, since there are other elastomer types listed which do not enter into adhesive bonding with the “hard plastics” listed.

The prior art describes combinations of a very wide variety of hard and soft components (cf. WO 01/16232 A1, DE 100 17 486 A1, JP 08/065,785 and DE 41 09 936). Although those documents list polyacetal and polyester elastomer respectively within the list of a wide variety of possible hard and soft components, if the hard and soft components respectively listed are randomly combined the general result in the absence of particular process-technology measures, or in quite a few cases, will be absolutely no adhesive bonding between hard component and soft component.

It is an object of the present invention to provide novel composites which feature high bond strengths and which are composed of polyacetal with directly-molded-on functional elements composed of polyester elastomers by multicomponent injection molding.

Another object of the present invention consists in the provision of a process which can produce composites which have high bond strengths and which are composed of polyacetal with directly-molded-on functional elements composed of polyester elastomers.

The present invention provides a composite comprising polyacetal and at least one thermoplastic polyester elastomer formed by a polyacetal molding which has been partially or completely coated with the thermoplastic polyester elastomer or onto which one or more moldings composed of the thermoplastic polyester elastomer have been directly molded, where the polyacetal and the thermoplastic polyester elastomer have been bonded adhesively or cohesively to one another via injection of the thermoplastic polyester elastomer onto the polyacetal molding, and where the tensile bond strength between the polyacetal and the thermoplastic polyester elastomer is at least 0.5 N/mm².

The tensile bond strength present in the inventive composite or, respectively, achieved via the process of the invention between polyacetal and thermoplastic polyester elastomer is at least 0.5 N/mm², preferably at least 1.0 N/mm². This provides fully satisfactory handling. For functional parts greater adhesion is desirable—as a function of exposure to stress.

Any desired polyacetal, and indeed any of those selected from the group of the known polyoxymethylenes as described by way of example in DE-A 29 47 490, can be used as polyacetal used in the inventive composite. The materials here are generally unbranched linear polymers which generally contain at least 80 mol %, preferably at least 90 mol %, of oxymethylene units (—CH₂—O—). The term polyoxymethylenes here encompasses not only homopolymers of formaldehyde or its cyclic oligomers, such as trioxane or tetroxane, but also corresponding copolymers.

Homopolymers of formaldehyde or of trioxane are polymers whose hydroxy end groups have been chemically stabilized in a known manner with respect to degradation, e.g. via esterification or etherification.

Copolymers are polymers composed of formaldehyde or of its cyclic oligomers, in particular trioxane, and of cyclic ethers, of cyclic acetals and/or of linear polyacetals.

Comonomers that can be used are i) cyclic ethers having 3, 4, or 5, preferably 3, ring members, ii) cyclic acetals other than trioxane having from 5 to 11, preferably 5, 6, 7, or 8, ring members, and iii) linear polyacetals, amounts used in each case being from 0.1 to 20 mol %, preferably from 0.5 to 10 mol %.

The melt index (MFR value, 190/2.16) of the polyacetal polymers used is generally from 0.5 to 75 g/10 min (ISO 1133). It is also possible to use modified grades of POM in which, by way of example, impact modifiers, reinforcing materials, such as glass fibers, or other additives are present.

Among these modified POM grades are, by way of example, blends composed of POM with TPEU (thermoplastic polyurethane elastomer), with MBS (methyl methacrylate-butadiene-styrene core-shell elastomer), with methyl methacrylate-acrylate core-shell elastomer, with PC (polycarbonate), with SAN (styrene-acrylonitrile copolymer), or with ASA (acrylate-styrene-acrylonitrile copolymer compounded material).

The thermoplastic polyester elastomers used comprise multiblock copolymers which are composed of stiff polyamide segments and of flexible long-chain polyether or polyester segments.

TPEE are known per se. Examples of these are described in Handbook of Thermoplastic Polyesters, Vol. 1, pp. 581-3, Wiley-VCH, Weinhem, 2002.

Preferred thermoplastic polyester elastomers are copolyesters containing the repeat structural units of the formulae I and II, which have been linked to one another via ester bonds
—O-G-O—CO—R¹—CO— (I)
—O-D-O—CO—R²—CO— (II),
where G is a divalent radical of a long-chain glycol after removal of the hydroxy groups,
D is a divalent radical of an aliphatic glycol whose molecular weight is less than 250 after removal of the hydroxy groups,
R¹ and R², independently of one another, are a divalent radical of a dicarboxylic acid after removal of the carboxy groups, with the proviso that at least 70 mol % of the radicals R² are divalent aromatic radicals, and that from 15 to 95% by weight, based on the copolyester, of repeat structural units are of the formula (II).

The preferred thermoplastic copolyester elastomers are in essence composed of the repeat long-chain ester units described above of the formula I and of the repeat short-chain ester units of the formula II.

The expression “long-chain ester units” describes a reaction product of a long-chain glycol with a dicarboxylic acid. The number-average molecular weight of suitable long-chain glycols for preparation of the copolyesters is from 400 to 4000 and their melting point (DSC) is below 55° C. Preferred long-chain glycols for preparation of these copolyester elastomers are poly(alkylene oxide) glycols, where the alkylene moiety has from 2 to 8 carbon atoms, examples being poly(ethylene oxide) glycol, poly(propylene 1,2- and 1,3-oxide) glycol, poly(tetramethylene oxide) glycol, poly(pentamethylene oxide) glycol, poly(octamethylene oxide) glycol, and poly(butylene 1,2-oxide) glycol; random or block copolymers of ethylene oxide with propylene 1,2-oxide; and also polyformals obtainable via reaction of formaldehyde with glycols, e.g. pentamethylene glycol, or from mixtures of glycols, e.g. from mixtures composed of tetramethylene glycol and pentamethylene glycol. Other preferred long-chain glycols are aliphatic polyesters, e.g. polybutylene adipate, polybutylene succinate, or polycaprolactone. Other suitable long-chain polymeric glycols derive from polybutadiene glycols or from polyisoprene glycols, or else from copolymers composed of these units and the corresponding hydrogenated derivatives of these glycols.

Particularly preferred long-chain glycols used are poly(tetramethylene oxide) glycol whose number-average molecular weight is from 600 to 2000 and ethylene-oxide-capped poly(propylene oxide) glycol whose number-average molecular weight is from 1500 to 2800 and which contains from 15 to 35% of ethylene oxide.

The short-chain ester units are reaction products of diols of low molecular weight with a dicarboxylic acid or with a mixture of dicarboxylic acids.

At least 70 mol % of these short-chain ester units have radicals R² derived from aromatic dicarboxylic acids, e.g. isophthalic acid or in particular terephthalic acid.

Diols of low molecular weight for reaction to give short-chain ester units are aliphatic diols whose molecular weights are less than 250. The expression “aliphatic diol” also encompasses cycloaliphatic diols.

It is preferable to use diols having from two to fifteen carbon atoms. Examples of preferred diols are ethylenebisglycol, propylene glycol, tetramethylene glycol, pentamethylene glycol, 2,2-dimethyltrimethylene glycol, hexamethylene glycol, and decamethylene glycol, dihydroxy-cyclohexane, cyclohexanedimethanol, and mixtures of these.

Instead of the diols, it is possible to use their ester-forming derivatives, e.g. ethylene oxide or ethylene carbonate.

Dicarboxylic acids which can be used for preparation of the long-chain and short-chain ester units described are aliphatic, cycloaliphatic, aromatic and/or dicarboxylic acids, of low molecular weights, usually below 300.

The expression “dicarboxylic acids” also encompasses their polyester-forming derivatives, such as the halides, esters, or anhydrides of dicarboxylic acids.

For the purposes of this invention, “aliphatic dicarboxylic acids” are carboxylic acids which have two carboxy groups which have been bonded to different carbon atoms of an aliphatic or cycloaliphatic hydrocarbon. Alongside ethylenically unsaturated dicarboxylic acids, such as maleic acid, saturated dicarboxylic acids are in particular used.

For the purposes of this invention, “aromatic dicarboxylic acids” are carboxylic acids which have two carboxy groups which have been bonded to different carbon atoms of a benzene ring, which can be part of a ring system. The carboxy groups can also have been bonded to carbon atoms of different rings. A plurality of rings can have been fused to one another or can have been linked to one another via bridging groups, such as a direct carbon-carbon bond, —O—, —CH₂—, or —SO₂—.

Examples of aliphatic or cycloaliphatic dicarboxylic acids which can be used for preparation of the polyamide elastomers to be used according to the invention are sebacic acid, 1,3-cyclohexanedicarboxylic acid, 1,4-cyclo-hexanedicarboxylic acid, adipic acid, glutaric acid, succinic acid, carbonic acid, oxalic acid, azelaic acid, diethyldicarboxylic acid, 2-ethylsuberic acid, 2,2,3,3-tetramethylsuccinic acid, cyclopentanedicarboxylic acid, deca-hydro-1,5-naphthalenedicarboxylic acid, 4,4′-bicyclohexyldicarboxylic acid, decahydro-2,6-naphthalenedicarboxylic acid, 4,4′-methylenebis(cyclohexanecarboxylic acid), 3,4-furandicarboxylic acid, and 1,1-cyclobutanedicarboxylic acid.

Preferred aliphatic carboxylic acids are cyclohexanedicarboxylic acids and adipic acid.

These aliphatic dicarboxylic acids are preferably used together with isophthalic acid and very particularly preferably together with terephthalic acid.

Examples of aromatic dicarboxylic acids which can be used for preparation of the polyester elastomers to be used according to the invention are phthalic acid, isophthalic acid, terephthalic acid, dibenzoic acid, substituted dicarboxy compounds having two benzene rings, e.g. bis(p-carboxyphenyl)methane, p-oxy-(p-carboxyphenyl)benzoic acid, ethylenebis(p-oxybenzoic acid), 1,5-napthalenedicarboxylic acid, 2,6-naphthalene-dicarboxylic acid, 2,7-napthalenedicarboxylic acid, phenanthrene-dicarboxylic acid, anthracenedicarboxylic acid, 4,4′-sulfonyldibenzoic acid, and derivatives thereof which have C₁₋₁₂-alkyl or other substitution, e.g. halogen-, alkoxy-, and aryl-substituted derivatives. It is also possible to use hydroxycarboxylic acids, e.g. p-(β-hydroxyethoxy)benzoic acid.

Terephthalic acid is preferably used as aromatic dicarboxylic acid.

The short-chain ester units in the polyester elastomers used according to the invention preferably have at least 70 mol % of repeat structural units which derive from ethylene terephthalic units and/or from 1,4-butylene terephthalic units.

Very particularly preferably used polyester elastomers are polyetheresters based on polybutylene terephthalate as stiff segment, and polytetramethylene oxide as flexible segment.

The hardness range of the polyester elastomers used according to the invention is preferably from approximately Shore A 65 to approximately Shore D 75. The hardness here is also a measure of the proportion of the stiff polyester segments with respect to the flexible long-chain polyester segments.

The melt index of the polyester elastomers is measured at various temperatures, as a function of the melting behavior of the stiff polyester segments. It is also a measure of the degree of addition (molar mass of entire chains).

Conventional additives can also be present in the polyacetal and/or polyester elastomer used according to the invention, examples being stabilizers, nucleating agents, mold-release agents, lubricants, fillers, reinforcing materials, pigments, carbon black, light stabilizers, flame retardants, antistatic agents, plasticizers, and optical brighteners. The amounts present of the additives are conventional amounts.

The invention therefore provides a composite composed of polyacetal and of at least one polyester elastomer and also a process for its production, where a molding composed of polyacetal is first molded, onto which then a coating or at least one molding composed of the polyester elastomer is injected, the polyacetal bonding cohesively or adhesively to the polyester elastomer.

The inventive composite here is formed by a polyacetal molding which has been partially or completely coated with the polyester elastomer or onto which one or more moldings, also called functional parts, composed of the polyester elastomer have been directly molded. By way of example, this can be a flat polyacetal molding which bears on one side a layer composed of polyester elastomer. Examples of this are antislip substrates, grip recesses, operating units and switching units, functional parts provided with gaskets or with damping elements, and also interior and exterior cladding on two-wheeled vehicles, on other motor vehicles, on aircraft, on rail vehicles, and on watercraft, where by virtue of the polyacetal these have the required dimensional stability and by virtue of the polyamide elastomer layer they have the desired frictional property, sealing function, feel or appearance.

However, the composite can also be composed of one or more polyacetal moldings of any desired shape, onto which one or more moldings of any desired shape composed of the polyester elastomer have been directly molded. For the purposes of the present invention, the expression “directly molded on” is intended to mean that the functional elements have been directly injected onto the molding composed of polyacetal with which they are intended to enter into secure adhesive bonding, in a multicomponent injection molding process.

By virtue of the use of the polyester elastomers it is possible, by way of example, for sealing elements or damping elements composed of the elastomers to be directly molded onto the moldings composed of polyacetal, with no requirement for any other assembly steps.

A considerable cost saving in the production of the inventive composites can be achieved via the omission of the processing steps needed hitherto for the assembly of functional elements.

The inventive composite is produced by the well-known multicomponent injection molding process, where first the polyacetal is molded in the injection mold, i.e. is injected first, and then a coating or molding composed of the polyester elastomer is injected onto the polyacetal molding.

The invention also provides a process for production of the abovementioned composite, where multicomponent injection molding processes are used to mold at least one polyacetal molding and at least one other molding composed of polyester elastomer onto one another, the polyester elastomer being injected onto the polyacetal molding.

When the molding is manufactured, the melt temperature here is in the conventional range, i.e. for the polyacetals described above is in the range from about 180 to 240° C., preferably from 190 to 230° C. The mold itself is preferably temperature-controlled to a temperature in the range from 20 to 140° C. A mold temperature in the above temperature range is advantageous for the precision of molding and dimensional stability of the hard component composed of polyacetal, which is a semicrystalline material.

As soon as the cavity in the mold has been filled completely and the hold pressure has no further effect (gate-sealing point), the polyacetal molding can be subjected to full and final cooling and can be demolded as the first part of the composite (premolding). In a second, subsequent separate injection molding step, by way of example, this premolding is then inserted or transferred into another mold whose cavity has additional space, and the material with the lower hardness, i.e. the polyester elastomer, is injected into the mold and thus injected onto the polyacetal molding. This process is known as the insert process or transfer process. With respect to the adhesion subsequently achievable, it is particularly advantageous for the polyacetal molding first injection-molded to be preheated to a temperature in the range from 80° C. to just below the melting point. This facilitates incipient melting of the surface via the polyester elastomer injected onto the material and penetration of this elastomer into the interface layer.

However, in another possible method the polyacetal molding first injection-molded is only partially demolded and is moved together with a portion of the original mold (e.g. the feed plate, the ejector half, or just one indexing plate) into another larger cavity.

Another possible method consists in injecting the polyester elastomer into the same mold, without intermediate opening of the machine and onward transport of the premolding composed of polyacetal. Here, the mold cavities intended for the polyester elastomer component are initially sealed via displaceable inserts or cores during injection of the polyacetal component, and are not opened until the polyester elastomer component is injected (split technique). This version of the process is also particularly advantageous for achieving good adhesion, since the melt of the polyester elastomer encounters a premolding which is still hot, after only a short cooling time.

It appropriate, further moldings composed of polyacetal and of the polyester elastomer can be applied by injection molding simultaneously or in sequential steps by the multicomponent injection molding process.

When the polyester elastomer is applied by injection molding, for good adhesion it is advantageous to select maximum possible settings for the melt temperature. The melt temperature of the polyester elastomer is generally in the range from 200 to 300° C., with an upward limit imposed by its decomposition. The values for injection rate and also for injection pressure and hold pressure are machine- and molding-dependent and are to be matched to the particular circumstances.

In all of the versions of the process, with or without demolding of the premolding, the mold is temperature-controlled in the second step to a temperature in a range which is preferably from 20° C. to 140° C. As a function of the structure of the parts, it can be advisable to lower the mold temperature somewhat, in order to optimize demoldability and cycle times. Once the parts have cooled, the composite is demolded. An important factor here related to the design of the mold is to attach the ejectors at a suitable site which minimizes the loading on the bonded joint of the materials. Sufficient venting of the cavity in the joint region is also to be provided in the design of the mold, in order to minimize inhibition of bonding between the two components via included air. A similar effect results from the nature of the roughness of the mold wall. For development of good adhesion, the surface at the site of the bonded joint is advantageously smooth, since less air is then included in the surface.

The components in the inventive process have different hardness. The inventive composites are used as bonding elements in the form of fittings, couplings, rollers, bearings, or as functional parts with integrated sealing properties and/or with integrated damping properties, or else as non-slip and easy-grip elements. Among these are in particular housings used in automobile construction, such as door closure housings, window lifter housings, or sliding-roof sealing elements, and also fastening elements with an integrated seal, such as clips with sealing rings or with sealing disks, decorative strips with an integrated sealing lip, sealing elements for compensation in expansion joints, fastening elements with good damping properties, e.g. clips with cores for damping of vibration or of noise, power train components, such as gearwheels with damping elements, gearboxes with integrated flexible couplings, non-slip, easy-grip elements, such as control levels or control knobs, or grip surfaces on electrical devices or on writing implements, and also chain links with a resilient surface.

The adhesion between the hard polyacetal component and the soft, thermoplastic polyamide elastomer component can be determined by means of a test method described in WO-A-99/16,605.

The examples below illustrate, but do not restrict, the invention.

### EXAMPLES 1-24

The injection molding experiments used a three-component injection molding machine with locking force of 2000 kN (FM 175/200, manufactured by Klöckner Ferromatik, Malterdingen, Federal Republic of Germany). From the three screws available, an assembly whose diameter was 45 mm was selected for use. In a cavity closed on one side, modified ISO tensile specimens were first premolded with one shoulder composed of material 1. For the polyacetal grades used, melt temperature was 200° C. and mold temperature was 80° C.

The resultant halved tensile specimens composed of polyacetal were preheated in a heating cabinet with air circulation at a temperature Tᵢₙₛ of 155° C. and were placed while still hot, within about 20 sec, into the fully open tensile specimen mold. In a second injection molding operation, material 2 was injected into the tensile specimen mold at various melt temperatures Tₘₑ and mold temperatures Tₘₒ at different injection rates vᵢ. Different hold pressures Pₐ and hold pressure times tpa were used. The resultant tensile specimens composed of two components were tested by the ISO 527 tensile test, using a separation velocity of 50 mm/min. The result of the tensile test was used to determine the tensile strength of the specimens at break at the jointing seam (bond strength) and the associated tensile strain at break. Ten tensile specimens were tested in each test. The values obtained for the 10 test specimens were averaged. The table below lists the details of conduct of the tests and the results thus obtained.

| | | | | | | | | | Tensile |
|---|---|---|---|---|---|---|---|---|---|
| | | | | | | | | Bond | strain at |
| Ex. | Material | Material | Tₘₑ | Tₘₒ | pₐ | tpa | vᵢ | strength | break |
| No. | 1¹⁻³⁾ | 2⁴⁾ | (° C.) | (° C.) | (bar) | (sec) | (mm/sec) | (N/mm²) | (%) |
| 1 | C 9021 | Arnitel | 210 | 60 | 35 | 15 | 100 | 2.7 | 2.7 |
| | | EM 400 | | | | | | | |
| 2 | C 9021 | Arnitel | 220 | 60 | 35 | 15 | 100 | 3.0 | 3.3 |
| | | EM 400 | | | | | | | |
| 3 | C 9021 | Arnitel | 230 | 60 | 35 | 15 | 100 | 3.9 | 4.7 |
| | | EM 400 | | | | | | | |
| 4 | C 9021 | Arnitel | 240 | 60 | 35 | 15 | 100 | 4.2 | 5.5 |
| | | EM 400 | | | | | | | |
| 5 | C 9021 | Arnitel | 250 | 60 | 35 | 15 | 100 | 5.2 | 5.6 |
| | | EM 400 | | | | | | | |
| 6⁵⁾ | C 9021 | Arnitel | 250 | 60 | 35 | 15 | 100 | 4.8 | 6.3 |
| | | EM 400 | | | | | | | |
| 7⁶⁾ | C 9021 | Arnitel | 250 | 60 | 35 | 15 | 100 | no | no |
| | | EM 400 | | | | | | adhesion | adhesion |
| 8 | C 9021 | Arnitel | 250 | 60 | 35 | 15 | 150 | 4.7 | 6.5 |
| | | EM 400 | | | | | | | |
| 9 | C 9021 | Arnitel | 250 | 60 | 35 | 15 | 50 | 4.3 | 5.8 |
| | | EM 400 | | | | | | | |
| 10 | C 9021 | Arnitel | 250 | 60 | 35 | 30 | 100 | 4.1 | 5.3 |
| | | EM 400 | | | | | | | |
| 11 | C 9021 | Arnitel | 250 | 60 | 45 | 30 | 100 | 3.5 | 4.1 |
| | | EM 400 | | | | | | | |
| 12 | C 9021 | Arnitel | 250 | 80 | 35 | 30 | 100 | 3.4 | 3.8 |
| | | EM 400 | | | | | | | |
| 13 | C 9021 | Arnitel | 260 | 80 | 35 | 30 | 100 | 3.1 | 3.3 |
| | | EM 400 | | | | | | | |
| 14 | C 9021 | Arnitel | 260 | 60 | 35 | 15 | 100 | 4.8 | 7.6 |
| | | EM 400 | | | | | | | |
| 15 | C 9021 | Arnitel | 270 | 60 | 35 | 15 | 100 | no | no |
| | | EM 400 | | | | | | adhesion | adhesion |
| 16 | S 9064 | Arnitel | 210 | 60 | 35 | 15 | 100 | 2.3 | 2.2 |
| | | EM 400 | | | | | | | |
| 17 | S 9064 | Arnitel | 250 | 60 | 35 | 15 | 100 | 3.8 | 5.1 |
| | | EM 400 | | | | | | | |
| 18⁶⁾ | S 9064 | Arnitel | 250 | 60 | 35 | 15 | 100 | no | no |
| | | EM 400 | | | | | | adhesion | adhesion |
| 19 | S 9244 | Arnitel | 210 | 60 | 35 | 15 | 100 | 1.9 | 2.1 |
| | | EM 400 | | | | | | | |
| 20 | S 9244 | Arnitel | 220 | 60 | 35 | 15 | 100 | 2.0 | 2.0 |
| | | EM 400 | | | | | | | |
| 21 | S 9244 | Arnitel | 230 | 60 | 35 | 15 | 100 | 3.1 | 3.6 |
| | | EM 400 | | | | | | | |
| 22 | S 9244 | Arnitel | 240 | 60 | 35 | 15 | 100 | 3.5 | 4.2 |
| | | EM 400 | | | | | | | |
| 23 | S 9244 | Arnitel | 250 | 60 | 35 | 15 | 100 | 3.9 | 5.0 |
| | | EM 400 | | | | | | | |
| 24⁶⁾ | S 9244 | Arnitel | 250 | 60 | 35 | 15 | 100 | no | no |
| | | EM 400 | | | | | | adhesion | adhesion |

¹⁾Hostaform ® C 9021: polyoxymethylene copolymer composed of trioxane and about 2% by weight of ethylene oxide, MF melt index 190/2.16 (ISO 1133): 9 g/10 min, no modification (Ticona GmbH)
²⁾Hostaform ® S 9064: polyoxymethylene copolymer composed of trioxane and about 2% by weight of ethylene oxide, MF melt index 190/2.16 (ISO 1133): 9 g/10 min, modification: 20% by weight of thermoplastic polyurethane (Ticona GmbH)
³⁾Hostaform ® C 9244: polyoxymethylene copolymer composed of trioxane and about 2% by weight of ethylene oxide, MF melt index 190/2.16 (ISO 1133): 9 g/10 min, modification: 25% by weight of MBS core-shell modifier composed of about 80% by weight of elastic polybutadiene core and about 20% by weight of MMA/styrene shell with particle size of about 100 nm (Ticona GmbH)
⁴⁾Arnitel ® EM 400: thermoplastic polyetherester elastomer composed of polytetramethylene oxide and polybutylene terephthalate (DSM)
⁵⁾Tᵢₙₛ = 100° C.
⁶⁾Tᵢₙₛ = 23° C.

1. A composite comprising polyacetal and at least one thermoplastic polyester elastomer formed by a polyacetal molding which has been partially or completely coated with the thermoplastic polyester elastomer or onto which one or more moldings composed of the thermoplastic polyester elastomer have been directly molded, wherein the polyacetal and the thermoplastic polyester elastomer have been bonded adhesively or cohesively to one another via injection of the thermoplastic polyester elastomer onto the polyacetal molding, and wherein the tensile bond strength between the polyacetal and the thermoplastic polyester elastomer is at least 0.5 N/mm².

2. The composite as claimed in claim 1, wherein the tensile bond strength between the polyacetal and the thermoplastic polyester elastomer is at least 1.0 N/mm².

3. The composite as claimed in claim 1, wherein the polyacetal used comprises a polyoxymethylene copolymer.

4. The composite as claimed in claim 1, wherein the polyacetal molding and/or the polyester elastomer molding has additives which are selected from the group consisting of stabilizers, nucleating agents, impact modifiers, mold-release agents, lubricants, fillers, reinforcing materials, pigments, carbon black, light stabilizers, flame retardants, antistatic agents, plasticizers, and optical brighteners.

5. The composite as claimed in claim 1, wherein the hardness of the thermoplastic polyester elastomer is in the range from Shore A 65 to Shore D 75.

6. The composite as claimed in claim 1, wherein the thermoplastic polyester elastomer used comprises a thermoplastic polyetherester elastomer.

7. The composite as claimed in claim 6, wherein the thermoplastic polyetherester elastomer is a polyetherester that has polybutylene terephthalate as stiff segment and polytetramethylene oxide as flexible segment.

8. The composite as claimed in claim 1, wherein the polyacetal molding has been completely or partially coated with thermoplastic polyester elastomer.

9. The composite as claimed in claim 1, wherein at least one other molding composed of thermoplastic polyester elastomer has been molded onto the polyacetal molding.

10. A process for producing the composite as claimed in claim 1, which comprises using multicomponent injection molding processes to mold at least one polyacetal molding and at least one other molding composed of thermoplastic polyester elastomer onto one another, the polyester elastomer being injected onto the polyacetal molding.

11. The process as claimed in claim 10, wherein, prior to the molding-on of the thermoplastic polyester elastomer, the polyacetal molding is preheated to a temperature in the range from 80° C. to just below its melting point, and the melt temperature of the thermoplastic polyester elastomer during the process of molding onto the polyacetal molding is from 200 to 300° C., and the mold has been temperature-controlled to a temperature in the range from 20 to 140° C.

12. The process as claimed in claim 11, wherein, prior to the molding-on of the thermoplastic polyamide elastomer, the polyacetal molding is preheated to a temperature in the range from 100 to 160° C., and the melt temperature of the thermoplastic polyester elastomer during the process of molding onto the polyacetal molding is from 220 to 260° C., and the mold has been temperature-controlled to a temperature in the range from 30 to 80° C.

13. (canceled)

14. A connector or a functional component with integrated sealing properties and/or with integrated damping properties, or else as non-slip and easy-grip element which comprises the composite as claimed in claim 1.

15. A composite comprising polyacetal and at least one thermoplastic polyester elastomer formed by a polyacetal molding onto which one or more moldings composed of the thermoplastic polyester elastomer have been directly molded, wherein the polyester elastomer is a polyetherester elastomer wherein, the polyacetal and the thermoplastic polyester elastomer have been bonded to one another, and wherein the tensile bond strength between the polyacetal and the thermoplastic polyester elastomer is at least 0.5 N/mm² (determined in the tensile test to ISO 527).
